(19) United States
(12) Patent Application Publication
(10) Pub. No.: US 2016/0036335 A1
(43) Pub. Date: Feb. 4, 2016

(54) RECTIFYING AND SMOOTHING CIRCUIT, POWER SUPPLY DEVICE AND IMAGE FORMING APPARATUS

(71) Applicant: CANON KABUSHIKI KAISHA, Tokyo (JP)

(72) Inventor: Keizo Kojima, Yokohama-shi (JP)

(21) Appl. No.: 14/811,410

(22) Filed: Jul. 28, 2015

(30) Foreign Application Priority Data
Aug. 1, 2014 (JP) 2014-157861

(51) Int. Cl. H02M 3/335; G03G 15/00

(52) U.S. Cl. CPC H02M 3/33507; G03G 15/80

(57) ABSTRACT

A rectifying and smoothing circuit includes: a rectifying circuit, including four rectifying elements, for rectifying an AC voltage of an AC voltage source; a smoothing circuit for smoothing the voltage rectified by the rectifying circuit; a filter circuit connected between the rectifying circuit and the smoothing circuit; and a first rectifying element, connected between the rectifying circuit and the filter circuit, shorter in reverse recovery time than the four rectifying elements. The first rectifying element is connected between a first output terminal of first and second output terminals of the rectifying circuit and a positive terminal of the smoothing circuit through the filter circuit, the first output terminal being capable of outputting a higher voltage than the second output terminal.

### FIELD OF THE INVENTION AND RELATED ART

The present invention relates to a rectifying and smoothing circuit, a power supply device and an image forming apparatus, particularly to the power supply device for generating a DV voltage from a commercial AC voltage. Specifically, the present invention relates to a rectifying means for rectifying an inputted AC voltage and suppression of noise generating due to the rectifying means.

In a conventional power supply device into which an AC voltage of a commercial AC voltage source is to be inputted, as a means for suppressing switching noise of an AC/DC converter or the like and noise due to reverse recovery of a diode bridge, the following filter has been known. That is, a noise filter consisting of a common mode choke coil, X-capacitor and Y-capacitor has been known. For example, Japanese Patent Publication No. Hei 05-002008 discloses a line filter having a constitution including a first filter circuit between the commercial AC voltage source and the diode bridge as the rectifying means and a second filter circuit between the diode bridge and an insulating transformer.

The noise of the power supply device into which the AC voltage of the commercial AC voltage source is to be inputted includes noise generating when a switching means operates and noise generating due to reverse recovery of the diode bridge as the rectifying means. In a constitution of a conventional circuit shown in FIG. 6 described later, the noise generating due to a diode bridge 11 is suppressed by a first filter circuit 23. However, when a load current of electronic equipment using the power supply device becomes large, there is a need to increase an allowable current value of a common mode choke coil 21 constituting the first filter circuit 23, so that a wire diameter of the coil 21 becomes large. As a result, such a problem that a size and cost of the common mode choke coil 21 increase generates. In the case where if the wire diameter of the common mode choke coil 21 is not made large, inductance required for removing the noise generating due to the diode bridge 11 cannot be obtained.

Further, independently of a magnitude of the load current of the electronic equipment including the power supply device, depending on the diode bridge used, there is a tendency that the noise due to the reverse recovery of the diode bridge 11 is liable to generate. For example, in a diode bridge constituted by a general-purpose silicon diode, a reverse recovery time trr is long in some cases. When the reverse recovery time trr is long, a recovery current (Id becomes large, so that noise in a reverse recovery period becomes large. In such a case, there is a need to further enhance a filtering effect by increasing an inductance value of the common mode choke coil 21 constituting the conventional first filter circuit 23 and a capacity (capacitance) value of the X-capacitor 22 also constituting the first filter circuit 23. There is a possibility that this consequently leads to increases in size and cost of an entirety of the power supply device.

### SUMMARY OF THE INVENTION

The present invention has accomplished in view of the above circumstances, and in a simple and inexpensive constitution, is capable of suppressing noise generating in a power supply device.

According to an aspect of the present invention, there is provided a rectifying and smoothing circuit comprising: a rectifying circuit, including four rectifying elements, for rectifying an AC voltage of an AC voltage source; a smoothing circuit for smoothing the voltage rectified by the rectifying circuit; a filter circuit connected between the rectifying circuit and the smoothing circuit; and a first rectifying element, connected between the rectifying circuit and the filter circuit, shorter in reverse recovery time than the four rectifying elements, wherein the first rectifying element is connected between a first output terminal of first and second output terminals of the rectifying circuit and a positive terminal of the smoothing circuit through the filter circuit, the first output terminal being capable of outputting a higher voltage than the second output terminal.

According to another aspect of the present invention, there is provided a power supply device comprising: rectifying means, including four rectifying elements, for rectifying an AC voltage of an AC voltage source; smoothing means for smoothing the voltage rectified by the rectifying means; a filter circuit connected between the rectifying circuit and the smoothing circuit; a converting portion for converting the voltage, smoothed by the smoothing means, into a DC voltage; and a first rectifying element, connected between the rectifying means and the filter circuit, shorter in reverse recovery time than the four rectifying elements, wherein the first rectifying element is connected between a first output terminal of first and second output terminals of the rectifying circuit and a positive terminal of the smoothing means through the filter circuit, the first output terminal being capable of outputting a higher voltage than the second output terminal.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a diagram showing a general full-wave rectifying circuit in an example.

In FIG. 2, (a) to (e) are diagrams each for illustrating noise generating due to a diode bridge in the example.

FIG. 3 is a diagram showing a circuit of a power supply device in Embodiment 1.

FIG. 4 is a diagram showing a circuit of a power supply device in Embodiment 2.

In FIG. 5, (a) is a diagram showing a circuit of a power supply device in Embodiment 3, and (b) is a schematic view showing an image forming apparatus in Embodiment 4.

FIG. 6 is a diagram showing a circuit of a power supply device in a conventional example.

### DESCRIPTION OF THE EMBODIMENTS

Embodiments of the present invention will be described specifically with reference to the drawings. Each of Embodiments 1 to 4 described below is an example of the present invention, and the technical scope of the present invention is not intended to be limited thereto.

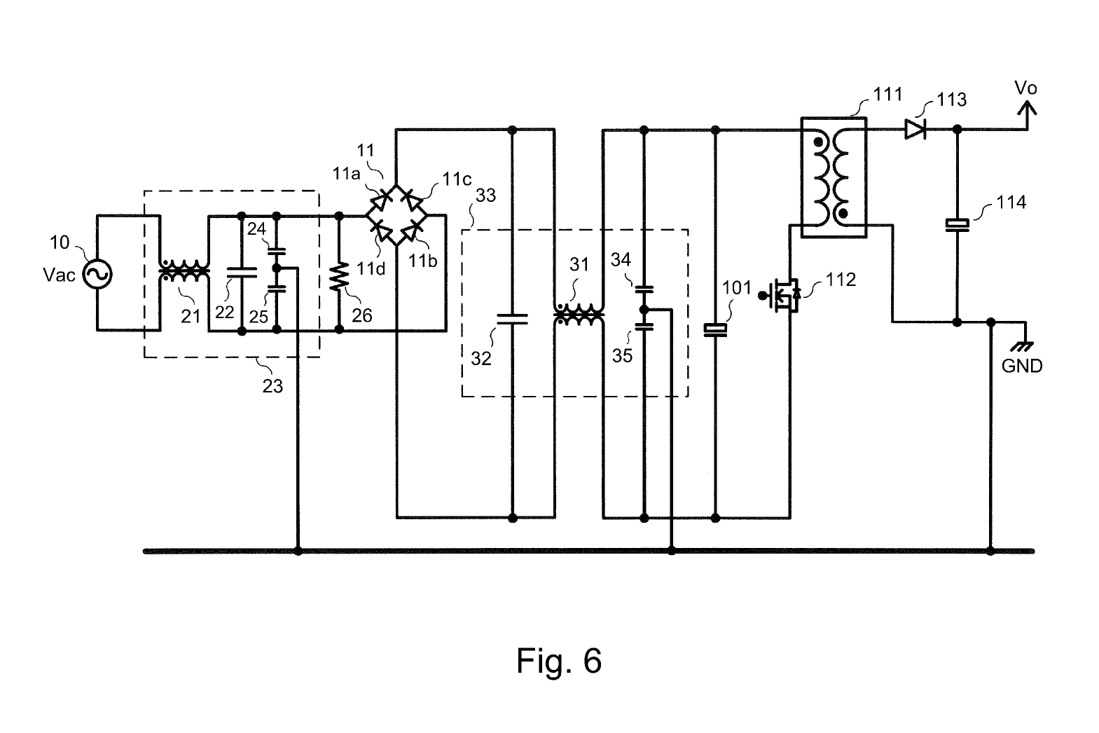

In order to make a comparison with Embodiments 1 to 4 described later, a constitution of a conventional power supply device shown in FIG. 6 will be described. A commercial AC voltage Vac of a commercial AC voltage source 10 is inputted into a diode bridge 11 as a rectifying means through a first filter circuit 23 indicated by a broken line, and then is rectified by the diode bridge 11. The filter circuit 23 is constituted by a common mode choke coil 21, an across-the-line capacitor (hereinafter referred to as X-capacitor) 22 and line-bypass capacitors (hereinafter referred to as Y-capacitors) 24 and 25. The filter circuit 23 suppresses noise generating due to reverse recovery of the diode bridge 11 described later. A resistor 26 is connected between the filter circuit 23 and the diode bridge 11.

The diode bridge 11 is constituted by four diodes 11a (second rectifying element), 11b (fourth rectifying element), 11c (third rectifying element) and 11d (fifth rectifying element). Specifically, at one input terminal of the diode bridge 11, an anode terminal of the diode 11a and a cathode terminal of the diode 11d are connected, and at the other input terminal of the diode bridge 11, an anode terminal of the diode 11c and a cathode terminal of the diode 11b are connected. Further, at one output terminal (first output terminal) of the diode bridge 11, cathode terminals of the diodes 11a and 11c are connected. Further, at the other output terminal (second output terminal) of the diode bridge 11, anode terminals of the diodes 11b and 11d are connected.

A voltage rectified by the diode bridge 11 is smoothened by a primary smoothing capacitor 101. Further, between the diode bridge 11 and the primary smoothing capacitor 101, a second filter circuit 33 indicated by a broken line is connected. The filter circuit 33 is constituted by an X-capacitor 32, a common mode choke coil 31 and Y-capacitors 34 and 35.

The voltage smoothened by the primary smoothing capacitor is inputted into an AC/DC converter as a converting means connected with a post stage. The AC/DC converter includes a transformer 111 for insulating a primary side and a secondary side, and with one end of the primary winding of the transformer 111, a switching FET 112 as a switching means is connected. The switching FET 112 performs a switching operation depending on a control signal inputted into a gate terminal by an unshown control circuit, so that an AC voltage is induced in the secondary side of the transformer. The AC voltage induced in the secondary side of the transformer 111 is rectified by a secondary-side rectifying diode 113 as a secondary-side rectifying means. Then, the voltage is smoothened by a secondary-side smoothing capacitor 114 as a secondary-side smoothing means, and then is outputted as a DC voltage Vo.

### <Noise Generating Due to Diode Bridge>

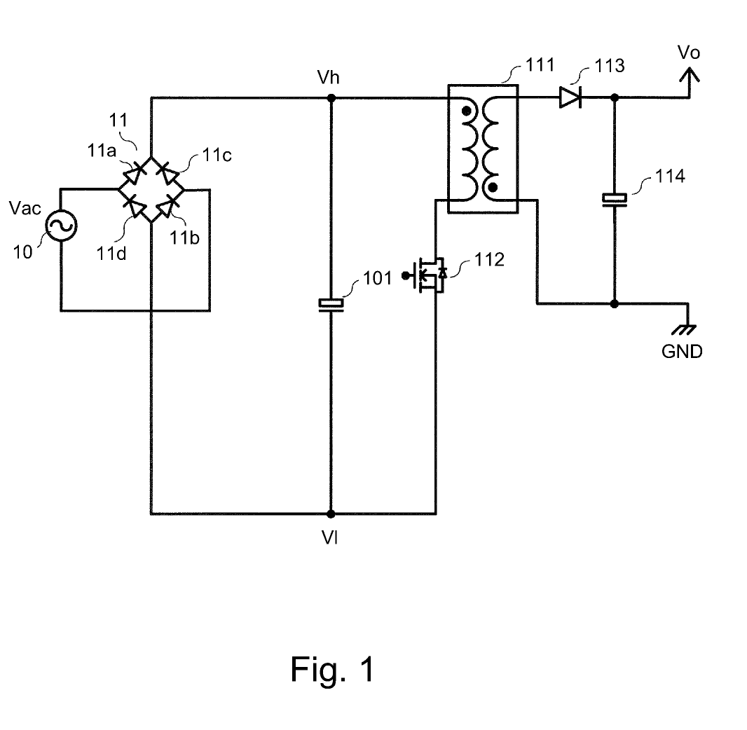

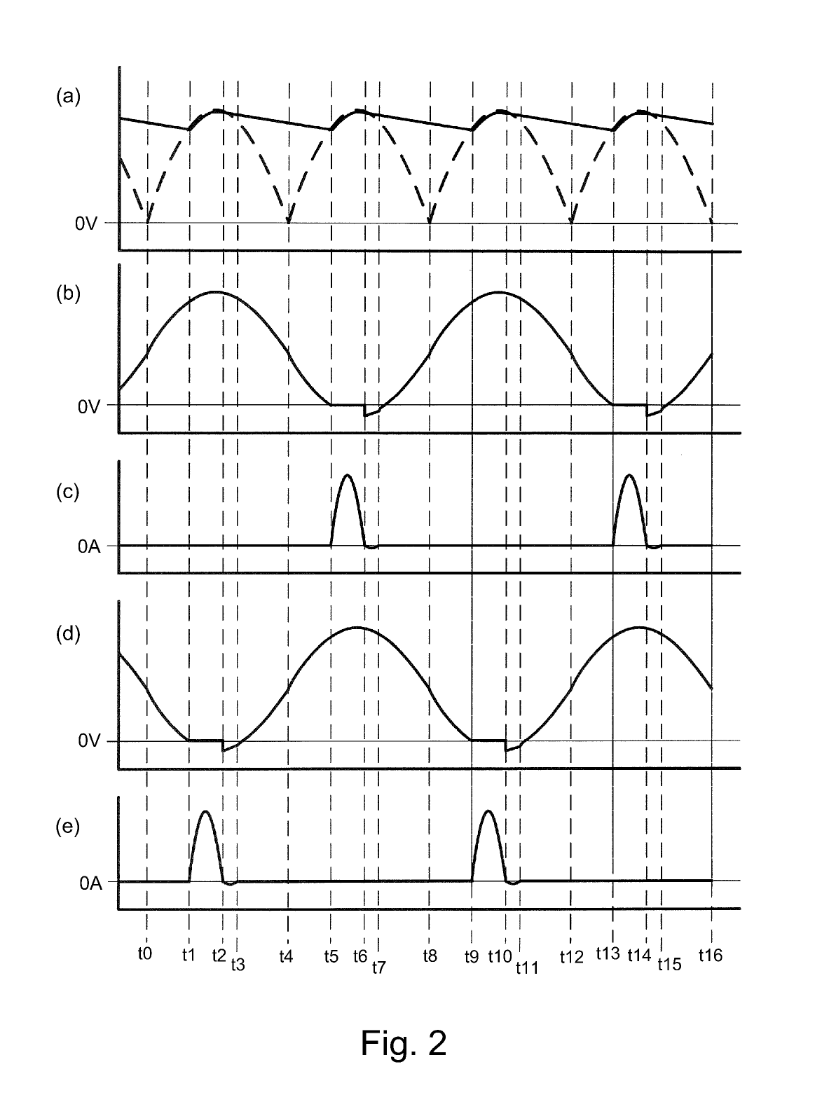

Using FIGS. 1 and 2, noise generating due to the diode bridge 11 will be described. FIG. 1 is a diagram showing a structure of a switching power supply device using a general-purpose commercial AC voltage source 10 as an input source, in which constituent elements identical to those described with reference to FIG. 6 are represented by the same reference numerals or symbols and will be omitted from description. The AC voltage Vac inputted from the commercial AC voltage source 11 is rectified by the diode bridge 11 and then is smoothened by the primary smoothing capacitor 101, so that substantially constant voltages Vh and Vl. Shapes of parts (components) used in the diode bridge 11 are not particularly limited. For example, the diode bridge 11 may only be required to be constituted so as to perform full-wave rectification in the form such as a bridged diode in which four diodes are packaged as a unit, a circuit constituted by an axial part of a single element or a circuit constituted by a lead part in which two elements are packaged. Here, when the voltage applied to the primary smoothing capacitor 101 is an end-to-end voltage Vc of the primary smoothing capacitor 101, the end-to-end voltage can be approximated by the following formula (1) by using the AC voltage Vac.

Vc=Vh−Vl=Vacᵣₘₛ×√2=Vacₚₖ (1),

where Vacᵣₘₛ is an effective value of the commercial AC voltage, and Vacₚₖ is a maximum (value) of the commercial AC voltage.

In FIG. 1, the end-to-end voltage Vc obtained by the formula (1) is an input voltage of the AC/DC converter consisting of the transformer 111, the switching FET 112, the secondary-side rectifying diode 113 and the second-side smoothing capacitor 114. When electric power is consumed by the AC/DC converter, waveforms of respective parts of the diode bridge 11 are as shown in (a) to (e) of FIG. 2.

In FIG. 2, (a) to (e) are diagrams for illustrating the noise generating due to diode bridge 11. In FIG. 2, (a) is the diagram showing the end-to-end voltage Vc (V) (solid line) of the primary smoothing capacitor 101 and a voltage (V) subjected to full-wave rectification by the diode bridge 11. In FIG. 2, (b) is the diagram showing the end-to-end voltage (V) on the basis of the anode terminal of the diode 11c of the diode bridge 11, and (c) is the diagram showing the current (A) flowing into the diode 11c. In FIG. 2, (d) is the diagram showing the end-to-end voltage (V) on the basis of the anode terminal of the diode 11a of the diode bridge 11, and (e) is the diagram showing the current (A) flowing into the diode 11a. In (a) to (e) of FIG. 2, the abscissa represents a time.

An operation waveform of the diode bridge 11 includes, in synchronism with a period of the inputted AC voltage Vac of the commercial AC voltage source 10, a first period in which the diodes 11a and 11b are electrically conducted and a second period in which the diodes 11c and 11d are electrically conducted. Here, the first period refers to t0-t4 and t8-t12. Further, the second period refers to t4-t8 and t12-t16.

When electric power is consumed by the AC/DC converter at the post stage of the diode bridge 11, in the first period, as shown by a period t1-t2 (t9-t10) in (e) of FIG. 2, a current flows through the diode 11a. In the period t1-t2 (t9-t10), the AC voltage Vac of the commercial AC voltage source 10 is higher than the end-to-end voltage Vc of the primary smoothing capacitor 101 by a normal-direction voltage Vd of the diode 11a. For this reason, in the period t1-t2 (t9-t10) in (a) of FIG. 2, the current flows from the commercial AC voltage source 10 into the primary smoothing capacitor 101 through the diodes 11a and 11b ((e) of FIG. 2). Thereafter, when the end-to-end voltage Vc of the primary smoothing capacitor 101 becomes higher than the AC voltage Vac of the commercial AC voltage source 10 (at the time t2 to t10), the current via the diodes 11a and 11b does not flow.

Here, in the general-purpose diode, there is a reverse recovery period in which when the period transfers from a period in which the voltage is applied in a normal direction to a period in which the voltage is applied in an opposite direction (to the normal direction), a current is caused to flow in the opposite direction by an accumulated carrier. The reverse recovery period of the diode is represented by a reverse recovery time trr. As shown in (e) of FIG. 2, the reverse recovery period of the diodes 11a and 11b is the period t2-t3 (t10-t11). In the reverse recovery period t2-t3, by the current flowing into the diode 11a in the opposite direction (hereinafter referred to as a recovery current), the end-to-end voltage of the diode 11a becomes such a voltage shown in the period t2-t3 in (d) of FIG. 2. A voltage change in the period t2-t3 shown in (d) of FIG. 2 is a noise terminal voltage which generates due to the diode bridge 11.

In this way, due to the diode bridge 11 into which the AC voltage Vac of the commercial AC voltage source 10 is to be inputted, the following noises generate. In the first period (e.g., t0-t4), the noise in the reverse recovery period generates in the diode 11a. Further, in the second period (e.g., t4-t8), the noise in the reverse recovery period (t6-t7, t14-t15) ((c) of FIG. 2) generates in the diode 11c ((b) of FIG. 2). That is, in synchronism with the period of the AC voltage Vac to be inputted from the commercial AC voltage source 10, the noise terminal voltage which is a noise level due to the diode bridge 11 is superposed on the AC primary Vac. As a result, the influence of the noise terminal voltage becomes large. Here, the operation of the power supply device in the second period (e.g., t4-t8) is similar to that in the first period (e.g., t0-t4) and therefore will be omitted from description.

The noise generating due to the diode bridge 11 generates by a flow of a recovery current Ir from the primary smoothing capacitor 101 toward the AC voltage Vac in the reverse recovery period of each of the diodes 11a and 11c of the diode bridge 11. That is, at the diode 11a, the recovery current Ir flows in the reverse recovery period t2-t3 (t10-t11) shown in (e) of FIG. 2, and at the diode 11c, the recovery current Ir flows in the reverse recovery period t6-t7 (t14-t15) shown in (c) of FIG. 2. In the case of the diodes 11a and 11c, a cathode terminal-side voltage is maintained by the primary smoothing capacitor 101. For this reason, when the flow of the current in the normal direction is ended, a potential difference between the AC voltage Vac and the end-to-end voltage Vc is applied to both terminals of each of the diodes 11a and 11c, so that the recovery current Ir flows.

On the other hand, at the diodes 11b and 11d, even in the reverse recovery period, the recovery current Ir is small, so that the noise does not generate. This is because a negative terminal voltage of the primary smoothing capacitor 101 fluctuates on the basis of the negative voltage of the commercial AC voltage source 10 and thus even when the flow of the current in the normal direction is ended, a potential difference does not so generate compared with the case of the diodes 11a and 11c. Further, the diode bridge is constituted by a diode of a fast recovery type in which the reverse recovery time trr is relatively short, the above-described noise due to the diode bridge does not generate. However, in the diode bridge constituted by the diode of the fast recovery type, the normal direction voltage of the diode becomes large, and therefore heat generation of the diode bridge becomes problematic.

### Embodiment 1

### (Power Supply Device)

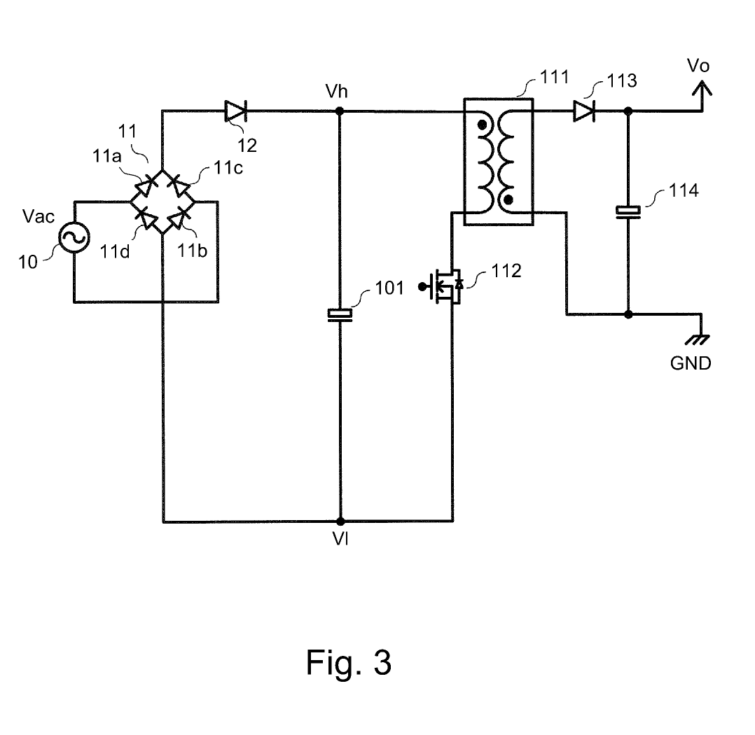

A structure of a power supply device in Embodiment 1 is shown in FIG. 3. A rectifying and smoothing circuit in this embodiment includes the diode bridge 11 for performing full-wave rectification and the primary smoothing capacitor 101 for smoothing the voltage subjected to the full-wave rectification. Further, a diode 12 as a first rectifying element is connected between a positive terminal of the primary smoothing capacitor 101 and a positive output terminal, of two output terminals of the diode bridge 11, for outputting a higher voltage. An anode terminal of the diode 11a of the diode bridge 11 is connected with the commercial AC voltage source 10, and a cathode terminal of the diode 11a is connected with the positive terminal of the primary smoothing capacitor 101. Further, also an anode terminal of the diode 11c of the diode bridge 11 is connected with the commercial AC voltage source 10, and a cathode terminal of the diode 11c is connected with the positive terminal of the primary smoothing capacitor 101. The diode 12 is characterized in that compared with a general-purpose silicone diode, the diode 12 is of the fast recovery type in which the reverse recovery time trr is short. Incidentally, constituent elements identical to those described with reference to FIG. 1 and the like are represented by the same reference numerals or symbols and will be omitted from description.

The noise generating due to the diode bridge 11 generates by the flow of the recovery current Ir from the primary smoothing capacitor 101 to the commercial AC voltage source 10 in the reverse recovery period of each of the diodes 11a and 11c of the diode bridge 11. In general, the diode bridge for rectifying the AC voltage of the commercial AC voltage source is constituted by the silicone diode suitable for use at a frequency of 1 kHz or less. Such a diode bridge has a relatively long reverse recovery time trr of several tens of μsec to several hundreds of μsec, and therefore the above-described noise due to the diode bridge is liable to generate. On the other hand, the diode 12 of the fast recovery type is the silicon diode improved in reverse recovery time trr, and therefore the reverse recovery time trr is not more than 100 nsec which is short. For that reason, with respect to the diode 12, in a relatively short time compared with the reverse recovery time trr of the diodes 11a and 11c of the diode bridge 11, the reverse recovery period in which the current can be caused to flow by the accumulated carrier is ended, so that the period transfers to a period in which the voltage is applied in the opposite direction (to the normal diode).

As described above, in this embodiment, a constitution in which the diode 12 which is the fast recovery diode is disposed between the positive output terminal of the diode bridge 11 and the positive terminal of the primary smoothing capacitor 101 is employed. As a result, the recovery current Ir flowing toward the diodes 11a and 11c of the diode bridge 11 is limited, so that it is possible to suppress the noise generating due to the diode bridge 11.

That is, according to the constitution of this embodiment, even in the case a load current of electronic equipment using the power supply device, the noise generating due to the diode bridge can be suppressed with increasing the filtering effect of the filter circuit. For that reason, increases in size and cost of the entirety of the power supply device can be suppressed, so that the noise can be suppressed. Incidentally, in this embodiment, the diodes 11a-11d constituting the diode bridge 11 are constituted by a schottky-barrier diode or the general-purpose silicone diode. That is, the diodes 11a-11d constituting the diode bridge 11 are constituted by a diode which is longer in reverse recovery time than the diode 12 being the fast recovery diode and which is lower in normal direction voltage than the diode 12. The schottky-barrier diode is low in normal direction voltage and is excellent in heat generation characteristic.

As described above, according to this embodiment, by a simple and inexpensive constitution, the noise generating in the power supply device can be suppressed.

### Embodiment 2

### (Power Supply Device)

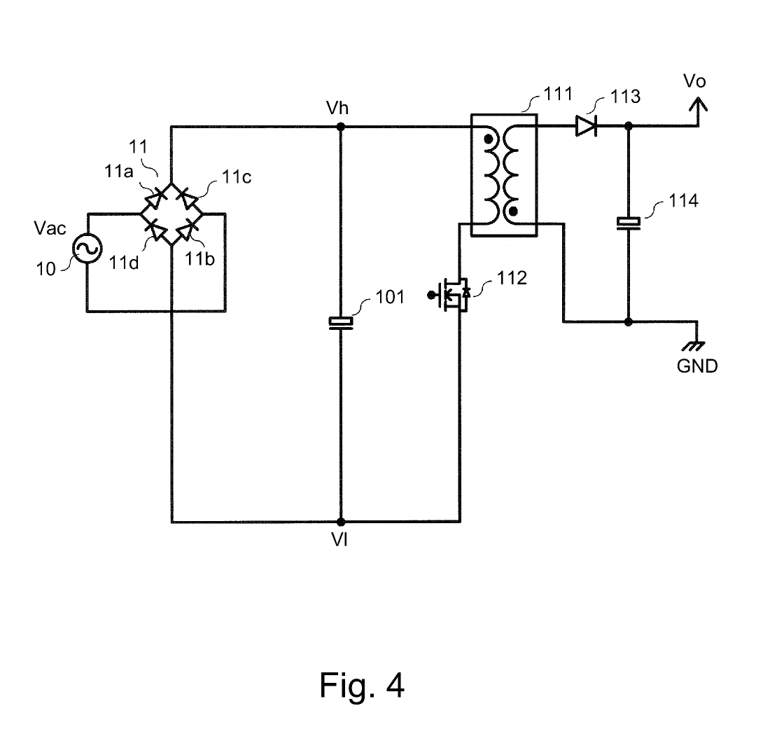

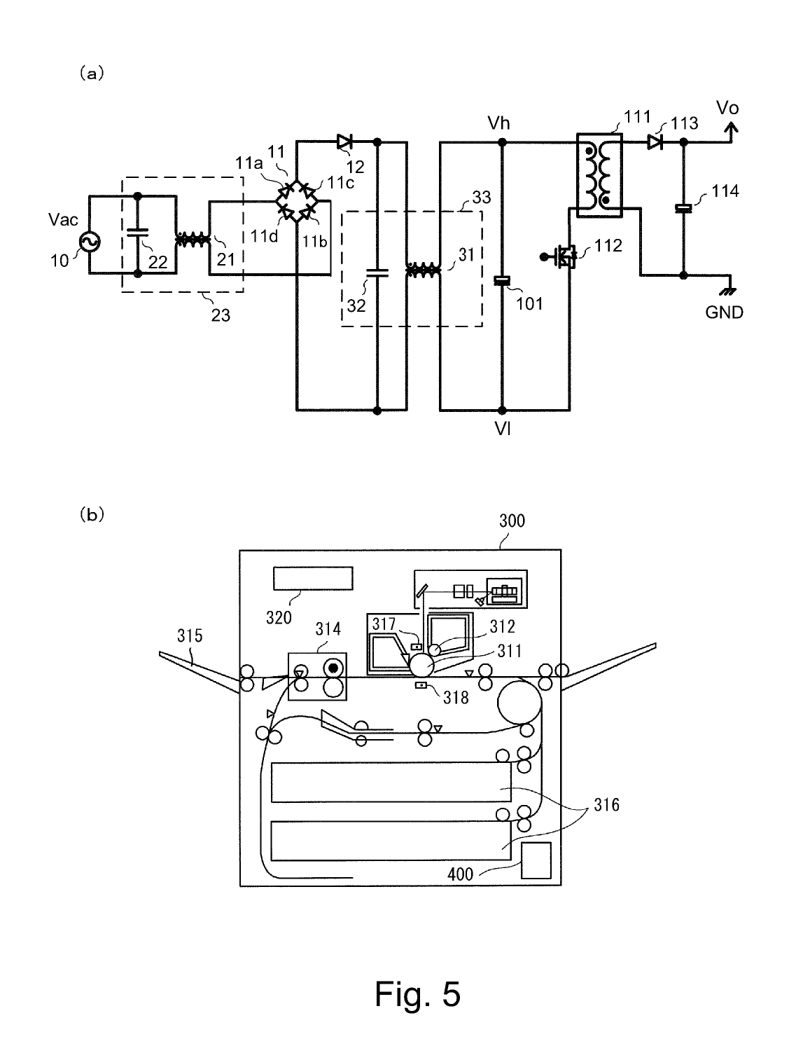

A structure of a power supply device in Embodiment 2 is shown in FIG. 4. Incidentally, constituent elements identical to those described with reference to FIG. 3 are represented by the same reference numerals or symbols and will be omitted from description. In this embodiment, the diodes 11a and 11c of the diode bridge 11 are constituted by the fast recovery diode. Of the four diodes of the diode bridge 11, only the diodes 11a and 11c each of which is the diode having the cathode terminal connected with the positive terminal of the primary smoothing capacitor 101 are constituted by the fast recovery diode. As a result, also in this embodiment, an effect similar to that in Embodiment 1 can be obtained.

In this embodiment, as the diodes 11b and 11d of the diode bridge 11, the general-purpose silicon diode or the schottky-barrier diode which is low in normal direction voltage and which is excellent in heat generation characteristic is used. Further, of the diodes 11a-11d constituting the diode bridge 11, the diodes 11b and 11d each having the anode terminal connected with the negative terminal of the primary smoothing capacitor may also be constituted as follows, for example. That is, the diodes 11b and 11d may also be constituted by a diode which is long in reverse recovery time and low in normal direction voltage than the diodes 11a and 11c. As a result, while suppressing the noise generating due to the reverse recovery of the diodes 11a and 11c of the diode bridge 11, a degree of the heat generation can be suppressed compared with the case where all of the four diodes 11a-11d are constituted by the fast recovery diode.

That is, according to the constitution of this embodiment, the noise generating due to the diode bridge can be suppressed with increasing the filtering effect of the filter circuit and without increasing the number of parts (components). For this reason, increases in size and cost of the entirety of the power supply device can be suppressed, so that the noise can be suppressed. Further, according to the constitution of this embodiment, compared with the diode bridge constituted by the four diodes which are all constituted by the fast recovery diode, it is possible to suppress the heat generation while maintaining the suppressing effect of the noise generation due to the diode bridge.

As described above, according to this embodiment, by a simple and inexpensive constitution, the noise generating in the power supply device can be suppressed.

### Embodiment 3

### (Power Supply Device)

A structure of a power supply device in Embodiment 3 is shown in (a) of FIG. 5. In (a) of FIG. 5, to the constitution of Embodiment 1, a filter circuit 23 provided between the commercial AC voltage source 10 and the diode bridge 11 and a filter circuit 33 provided between the primary smoothing capacitor 101 and the diode 12 which is the fast recovery diode are added. The filter circuit 23 is constituted by the common mode choke coil 21 and the X-capacitor 22. The filter circuit 33 is constituted by the common mode choke coil 31 and the X-capacitor 32. Incidentally, constituent elements identical to those described with reference to FIG. 2 are represented by the same reference numerals or symbols and will be omitted from description.

The filter circuit 23 suppresses the noise generating in a period in which the end-to-end voltage Vc of the primary smoothing capacitor 101 is lower than the AC voltage Vac of the commercial AC voltage source 10 and thus the normal direction current flows into the diode bridge 11. Specifically, when the switching FET 112 of the AC/DC converter operations in the period t1-t2 and the period t9-t10 shown in (a) of FIG. 2, the filter circuit 23 suppresses the noise generating in the reverse recovery periods t2-t3 and t10-tn. On the other hand, the filter circuit 33 suppresses, independently of whether or not the current flows into the diode bridge 11, the noise (switching noise) generating when the switching FET 112 of the AC/DC converter operations.

The constitution of this embodiment is not limited to the constitution of (a) of FIG. 5. For example, the constitution of this embodiment may also be a constitution in which the filter circuit 33 is connected but the filter circuit 23 is not connected in the circuit structure of (a) of FIG. 5 and a constitution in which the filter circuit 23 is connected by the filter circuit 33 is not connected in the circuit structure of (a) of FIG. 5. Further, the constitution of this embodiment may also be a filter constitution in which a Y-capacitor is provided at the preceding stage or the post stage of each of the common mode choke coils 21 and 31. In these constitutions, it is possible to obtain an effect similar to that of this embodiment. Further, the constitution of this embodiment may also be a constitution in which the filter circuits 23 and 33 are added to the constitution of Embodiment 2 (in which the diode 12 is removed and the diodes 11a and 11c are of the fast recovery type), and also in this case, the same effect as in this embodiment can be obtained.

As described above, according to this embodiment, while suppressing the noise generating due to the diode bridge, also the noise when the switching FET 112 of the AC/DC converter operations can be suppressed. For this reason, even in the case where the local current of the electronic equipment using the power supply device, the upsizing of the power supply device as a whole can be suppressed, so that the noise can be suppressed.

As described above, according to this embodiment, by a simple and inexpensive constitution, the noise generating in the power supply device can be suppressed.

### Embodiment 4

The power supply devices described in Embodiments 1 to 3 are applicable to a low-voltage source of the image forming apparatus, i.e., a power source for supplying electric power to a driving portion such as a controller or a motor. In the following, a constitution of an image forming apparatus to which the power supply devices of Embodiments 1 to 3 are applicable.

### [Image Forming Apparatus]

As an example of the image forming apparatus, a laser beam printer will be described. In FIG. 5, (b) illustrates a schematic structure of the laser beam printer which is an example of an electrophotographic printer. A laser beam printer 300 includes a photosensitive drum 311 as an image bearing member for forming an electrostatic latent image, a charging portion (charging means) 317 for electrically charging the photosensitive drum 311 uniformly, and a developing portion (developing means) 312 for developing, with a toner, the electrostatic latent image formed on the photosensitive drum 311. The toner image formed on the photosensitive drum 311 is transferred by a transfer portion (transfer means) 318 onto a sheet (not shown) as a recording material supplied from a cassette 316, and then the toner image transferred on the sheet is fixed by a fixing device 314 and thereafter the sheet is discharged onto a tray 315. The photosensitive drum 311, the charging portion 317, the developing portion 312 and the transfer portion 318 constitute an image forming portion. Further, the laser beam printer 300 includes a power supply device 400 as described in Embodiments 1 to 3. The image forming apparatus to which the power supply device 400 in Embodiments 1 to 3 applicable is not limited to the image forming apparatus shown in (b) of FIG. 5, but may also be an image forming apparatus including a plurality of image forming portions, for example. The image forming apparatus may also be an image forming apparatus including a primary transfer portion where the toner image is transferred from the photosensitive drum 311 onto an intermediary transfer belt and a secondary transfer portion where the toner image is transferred from the intermediary transfer belt onto the sheet.

The laser beam printer 300 includes a controller 320 for controlling an image forming operation by the image forming portion and a sheet feeding operation, and the power supply device in Embodiments 1 to 3 supplies electric power to the controller 320, for example. Further, the power supply device 400 in Embodiments 1 to 3 supplies the electric power to a motor or the like for driving various rollers for rotating the photosensitive drum 311 for feeding the sheet. In the case where the power supply device 400 has the constitution described in each of Embodiments 1 and 2, in the power supply device 400, the noise generating due to the diode bridge 11 can be suppressed. Further, in the case where the power supply device 400 has the constitution described in Embodiment 3, while suppressing the noise generating due to the diode bridge 11, it is possible to suppress also the switching noise when a load (motor or the like) of the power supply device 400 becomes large.

As described above, according to the image forming apparatus of this embodiment, by a simple and inexpensive constitution, the noise generating in the power supply device can be suppressed.

While the invention has been described with reference to the structures disclosed herein, it is not confined to the details set forth and this application is intended to cover such modifications or changes as may come within the purpose of the improvements or the scope of the following claims.

This application claims the benefit of Japanese Patent Application No. 2014-157861 filed on Aug. 1, 2014, which is hereby incorporated by reference herein in its entirety.

What is claimed is:

1. A rectifying and smoothing circuit comprising:
a rectifying circuit, including four rectifying elements, for rectifying an AC voltage of an AC voltage source;
a smoothing circuit for smoothing the voltage rectified by said rectifying circuit;
a filter circuit connected between said rectifying circuit and said smoothing circuit; and
a first rectifying element, connected between said rectifying circuit and said filter circuit, shorter in reverse recovery time than the four rectifying elements,
wherein said first rectifying element is connected between a first output terminal of first and second output terminals of said rectifying circuit and a positive terminal of said smoothing circuit through said filter circuit, the first output terminal being capable of outputting a higher voltage than the second output terminal.

2. A rectifying and smoothing circuit according to claim 1, wherein said first rectifying element is a fast recovery diode.

3. A rectifying and smoothing circuit according to claim 1, wherein each of the four rectifying elements is lower in normal-direction voltage than said first rectifying element.

4. A rectifying and smoothing circuit according to claim 1, wherein each of the four rectifying elements is a schottky-barrier diode.

5. A rectifying and smoothing circuit according to claim 1, wherein each of the four rectifying elements is a silicon diode.

6. A rectifying and smoothing circuit according to claim 1, wherein the four rectifying elements are a second rectifying element, a third rectifying element, a fourth rectifying element and a fifth rectifying element, and
wherein with the first output terminal, a cathode terminal of the second rectifying element and a cathode terminal of the third rectifying element are connected.

7. A rectifying and smoothing circuit according to claim 1, further comprising a second filter circuit connected between the AC voltage source and said rectifying circuit.

8. A rectifying and smoothing circuit according to claim 7, wherein said second filter circuit includes a common mode choke coil and a cross-the-line capacitor.

9. A rectifying and smoothing circuit according to claim 8, wherein said second filter circuit includes a line-bypass capacitor at a preceding stage or a post stage of the common mode choke coil.

10. A rectifying and smoothing circuit according to claim 7, wherein said filter circuit includes a common mode choke coil and a cross-the-line capacitor.

11. A rectifying and smoothing circuit according to claim 10, wherein said filter circuit includes a line-bypass capacitor at a preceding stage or a post stage of the common mode choke coil.

12. A power supply device comprising:
rectifying means, including four rectifying elements, for rectifying an AC voltage of an AC voltage source;
smoothing means for smoothing the voltage rectified by said rectifying means;
a filter circuit connected between said rectifying circuit and said smoothing circuit;
a converting portion for converting the voltage, smoothed by said smoothing means, into a DC voltage; and
a first rectifying element, connected between said rectifying means and said filter circuit, shorter in reverse recovery time than the four rectifying elements,
wherein said first rectifying element is connected between a first output terminal of first and second output terminals of said rectifying circuit and a positive terminal of said smoothing means through said filter circuit, the first output terminal being capable of outputting a higher voltage than the second output terminal.

13. A power supply device according to claim 12, wherein said first rectifying element is a fast recovery diode.

14. A power supply device according to claim 12, wherein each of the four rectifying elements is lower in normal-direction voltage than said first rectifying element.

15. A power supply device according to claim 12, wherein each of the four rectifying elements is a schottky-barrier diode.

16. A power supply device according to claim 12, wherein each of the four rectifying elements is a silicon diode.

17. A power supply device according to claim 12, wherein the four rectifying elements are a second rectifying element, a third rectifying element, a fourth rectifying element and a fifth rectifying element, and
wherein with the first output terminal, a cathode terminal of the second rectifying element and a cathode terminal of the third rectifying element are connected.

18. A power supply device according to claim 12, further comprising a second filter circuit connected between the AC voltage source and said rectifying circuit.

19. A power supply device according to claim 18, wherein said second filter circuit includes a common mode choke coil and a cross-the-line capacitor.

20. A power supply device according to claim 19, wherein said second filter circuit includes a line-bypass capacitor at a preceding stage or a post stage of the common mode choke coil.

21. A power supply device according to claim 18, wherein said filter circuit includes a common mode choke coil and a cross-the-line capacitor.

22. A power supply device according to claim 20, wherein said filter circuit includes a line-bypass capacitor at a preceding stage or a post stage of the common mode choke coil.

23. A power supply device according to claim 12, wherein said converting portion comprises,
a transformer for insulating a primary side and a secondary side,
a switching element for switching the voltage smoothed by said smoothing means,
secondary-side rectifying means for rectifying an AC voltage induced in the secondary side of said transformer, and
secondary-side smoothing means for smoothing the voltage rectified by said secondary-side rectifying means.

24. An image forming apparatus for forming an image on a recording material, comprising:
a power supply device according to claim 12.
